(19) United States
(12) Patent Application Publication
(10) Pub. No.: US 2024/0373772 A1
(43) Pub. Date: Nov. 14, 2024

(54) INTERCHANGEABLE GARDEN TOOL DEVICE

(71) Applicant: Jerry Rupprecht, Jefferson, WI (US)

(72) Inventor: Jerry Rupprecht, Jefferson, WI (US)

(21) Appl. No.: 18/474,576

(22) Filed: Sep. 26, 2023

Related U.S. Application Data
(60) Provisional application No. 63/500,774, filed on May 8, 2023.

(51) Int. Cl. A01B 1/02; A01B 1/20; A01D 7/08; A01D 9/04; B25G 1/04; B25G 1/10; B25G 3/30; B25G 3/38

(52) U.S. Cl. CPC A01B 1/022; A01B 1/20; A01D 7/08; A01D 9/04; B25G 1/04; B25G 1/102; B25G 3/30; B25G 3/38

(57) ABSTRACT

An interchangeable garden tool device is provided. The device is comprised of a handle, a shaft, various interchangeable attachment heads, and a mountable storage board. The handle and the attachment heads may removably attach to the shaft of the device. Additionally, the attachment head may have a plurality of tool shapes for any given yard or garden work need. The handle, shaft, and various attachment heads are stored on the mountable storage board to prevent clutter.

### CROSS-REFERENCE TO RELATED APPLICATION

The present application claims priority to, and the benefit of, U.S. Provisional Application No. 63/500,774, which was filed on May 8, 2023, and is incorporated herein by reference in its entirety.

### FIELD OF THE INVENTION

The present invention relates generally to the field of tools. More specifically, the present invention relates to an interchangeable garden tool device comprised of a shaft with various interchangeable tool heads that can be switched out to complete different yard, gardening, or other type of work. Accordingly, the present disclosure makes specific reference thereto. Nonetheless, it is to be appreciated that aspects of the present invention are also equally applicable to other like applications, devices, and methods of manufacture.

### BACKGROUND

When maintaining a yard or garden, many different tools are needed for numerous yardwork tasks. However, carrying each tool around can be cumbersome and frustrating for a gardener, landscaper, construction worker, homeowner, or other user. Additionally, storing each individual tool can be difficult in the limited space a garage, shed, or another storage receptacle has. Moreover, exchanging the head of a single tool shaft can save a user considerable time without the need for several trips to retrieve a needed tool.

Therefore, there exists a long-felt need in the art for a device that allows a user to change the head of a tool shaft to accommodate different yard working or gardening tasks. More specifically, there exists a long-felt need in the art for an interchangeable garden tool device that has interchangeable tool heads to eliminate the need for a user to possess a plurality of separate individual tools. Furthermore, there exists a long-felt need in the art for an interchangeable garden tool device that has interchangeable tool heads to eliminate the need for individual tools, wherein the device has a storage rack that can be universally attached to any garage, shed, or other storage receptacle wall.

The subject matter disclosed and claimed herein, in one embodiment thereof, comprises an interchangeable garden tool device. The device is comprised of a shaft that receives several interchangeable tool heads that can be used for various outdoor jobs and tasks. In one embodiment, the shaft is a fixed length. In another embodiment, the shaft is telescoping to accommodate various shaft lengths. Additionally, the device has a mountable storage frame that can be secured to any garage, shed, or other storage receptacle wall. The mountable storage frame can hold the shaft and the interchangeable tool heads.

In this manner, the interchangeable garden tool device of the present invention accomplishes all of the foregoing objectives and provides a universal yard working or gardening tool. More specifically, the interchangeable garden tool device eliminates the need for individual yard working or gardening tools because of the interchangeable tool heads. Furthermore, the device can be organized and stored on a mountable storage frame that can be attached to a garage, shed, or other storage receptacle wall, reducing the clutter of individual tools.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an interchangeable garden tool device comprised of at least one handle, at least one shaft, at least one attachment head, and at least one storage board. In one potential embodiment, the device is designed to attach the handle to the shaft, and the shaft to the attachment head for a user to utilize the device for yard or gardening work.

The shaft allows the user to work with the device while performing yard work, gardening work, outdoor work, etc. In one embodiment, the shaft may be a straight shaft comprised of any type of material known in the art, such as, but not limited to, metal, wood, plastic, etc. In another embodiment, the shaft may be angular or flexible to provide leverage for different tasks and made from any martial known in the art, such as, but not limited to, metal, wood, plastic, etc.

In one embodiment, the shaft may be fixed in length. Although, in another embodiment, the shaft may be telescoping to allow a user to lengthen or shorten the shaft. The telescoping shaft supports better reachability and storage of the device. In the telescoping embodiment, the shaft is comprised of a locking member that allows the shaft to be locked into the desired length. The locking member may be a plurality of locking members known in the art, such as, but not limited to, a twisting lock, a button lock, a telescoping clamp, etc.

Additionally, in one embodiment, the shaft is comprised of a first end with at least one first fastener that attaches to at least one fastener on at least one handle. The first fastener of the shaft and the fastener of the handle are generally reciprocating fasteners comprised of a female end and male end, respectively. In another embodiment, the shaft is not comprised of at least one fastener and does not attach to at least one handle.

The handle is comprised of a grip area. The grip area allows a user a place to grasp while handling the device. The grip area is comprised of a non-slip material, such as rubber or silicon. Moreover, the grip area may be raised or textured to promote a better grip while using the device. The handle is also comprised of an opening. The opening supplies a user with an area to stick at least one of a user's fingers or hands through the device.

Furthermore, the shaft is also comprised of a second end. The second end of the shaft is comprised of at least one second fastener. The second fastener attaches to at least one fastener of at least one attachment head. The second fastener of the shaft and the fastener of the attachment head are generally, reciprocating fasteners comprised of a male end and a female end, respectively. In different embodiments of the attachment head, the body of the attachment head may be a plurality of tool shapes known in the art, such as, but not limited to, shovels, brooms, hoes, rakes, axes, blades, etc.

Additionally, in one potential embodiment, the shaft is comprised of at least one pivot point. The pivot point allows a user to change the angle of the body of the attachment head to provide better leverage and optimally use the device. The pivot point is comprised of at least one button. The button locks the body of the attachment head in a user's desired position for device usage.

During use, in one potential embodiment, the device is comprised of at least one handle, at least one shaft, and at least one attachment head. In this embodiment, the device may be used as various shovels or pitchforks. In another potential embodiment of the device, it is only comprised of at least one shaft and at least one attachment head. During the use of a second embodiment, the device may be used as various shovels, brooms, hoes, rakes, etc.

Additionally, the device is comprised of a storage board. The storage board acts as an organizational piece that stores at least one shaft, at least one handle, and at least one attachment head. Furthermore, the storage board is comprised of a rear surface. The rear surface attaches the storage board to at least one wall of any storage receptacle known in the art, such as, but not limited to, a garage or a shed. The rear surface attaches to at least one wall via at least one fastener. The storage board is also comprised of a front surface that allows attachment to at least one fastener. The fastener of the front surface removably fixes at least one shaft, at least one handle, and at least one attachment head to the storage board.

The present invention is also comprised of a method of using the device. First, a device is provided comprised of a handle, a shaft, and an attachment head. Then, at least one fastener of a handle is fixed to at least one first fastener of a first end of the shaft. Then, at least one second fastener of a second end of the shaft is fixed to at least one fastener of a body of the attachment head. In one embodiment where the shaft is telescoping, a user can select the length of the shaft and lock the shaft into place via at least one locking member. In one embodiment where the shaft is comprised of at least one pivot point, a user adjusts the angle of the body of the attachment head and locks the attachment head into place via at least one button.

The present invention is also comprised of a second method of using the device. First, a device is provided comprised of a shaft and an attachment head. Then, at least one second fastener of a second end of the shaft is fixed to at least one fastener of a body of the attachment head. In one embodiment where the shaft is telescoping, a user can select the length of the shaft and lock the shaft into place via at least one locking member. In one embodiment where the shaft is comprised of at least one pivot point, a user adjusts the angle of the body of the attachment head and locks the attachment head into place via at least one button.

Accordingly, the interchangeable garden tool device of the present invention is particularly advantageous as it provides a device that exchanges tool heads on a shaft to eliminate the need for individual tools. The interchangeable garden tool device provides a user with a tool that accomplishes all yard working or gardening needs without carrying around multiple tools. Additionally, the interchangeable garden tool device may attach to a mountable storage frame. The mountable storage frame optimally stores the shaft and interchangeable tool heads to prevent clutter in a garage, shed, or another storage receptacle. In this manner, the interchangeable garden tool device overcomes the limitations of existing tools known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an interchangeable garden tool device of the present invention while disassembled and stored in accordance with the disclosed architecture;

FIG. 2 illustrates a perspective view of one potential embodiment of an interchangeable garden tool device of the present invention while assembled in accordance with the disclosed architecture;

FIG. 3 illustrates a perspective view of one potential embodiment of an interchangeable garden tool device of the present invention while assembled in accordance with the disclosed architecture;

FIG. 4 illustrates a flowchart of a method of using one potential embodiment of an interchangeable garden tool device of the present invention in accordance with the disclosed architecture; and

FIG. 5 illustrates a flowchart of a method of using one potential embodiment of an interchangeable garden tool device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can change the head of a tool shaft to accommodate different yard working or gardening tasks. More specifically, there exists a long-felt need in the art for an interchangeable garden tool device that has interchangeable tool heads to eliminate the need for individual tools. Furthermore, there exists a long-felt need in the art for an interchangeable garden tool device that has interchangeable tool heads to eliminate the need for individual tools, wherein the device has a storage rack that can be universally attached to any garage, shed, or another storage receptacle.

The present invention, in one exemplary embodiment, is comprised of an interchangeable garden tool device. The device is comprised of at least one handle, at least one shaft, at least one attachment head, and at least one storage board. During use, in one potential embodiment, the device is designed to attach the handle to the shaft, and the shaft to the attachment head for a user to utilize the device for yard or gardening work. In another embodiment, the device attaches at least one shaft to at least one attachment head without at least one handle.

In one embodiment, the shaft may be a straight shaft comprised of any type of material known in the art, such as, but not limited to, metal, wood, plastic, etc. In another embodiment, the shaft may be angular or flexible to provide better leverage for various tasks and be made from any martial known in the art, such as, but not limited to, metal, wood, plastic, etc. The shaft allows the user to handle the device while performing yard or gardening work.

The shaft may, additionally, be telescoping in length allowing a user to lengthen or shorten the shaft. The telescoping shaft permits better storage and reachability of the shaft. In the telescoping embodiment, the shaft is comprised of a locking member that allows the shaft to be locked into the desired length. The locking member may be any type of lock known in the art, such as, but not limited to, a twisting lock, a button lock, a telescoping clamp, etc. In another potential embodiment, the shaft may be fixed in length.

The shaft is also comprised of a first end with at least one first fastener. The first fastener attaches to at least one fastener on at least one handle. The first fastener of the shaft and the fastener of the handle are generally, reciprocating fasteners. The fastener of the handle and the first fastener of the shaft are comprised of a male end and female end, respectively. In another embodiment, the shaft is only comprised of a shaft and does not attach to at least one handle.

Additionally, the handle is comprised of a grip area. A user grasps the grip area while holding the device. The grip area is comprised of any non-slip material known in the art, such as, but not limited to, rubber or silicon. Furthermore, the grip area may be raised or textured to allow better grip while using the device. The handle is also comprised of an opening. The opening allows at least one of a user's hands to be placed through the opening of the handle.

Moreover, the shaft is also comprised of a second end that is comprised of at least one second fastener. The second fastener connects to at least one fastener of at least one attachment head. The second fastener of the shaft and the fastener of the attachment head are generally reciprocating fasteners. The second fastener of the shaft and the fastener of the attachment head are comprised of a male and a female end, respectively. In different embodiments of the attachment head, the body of the attachment head may be any tool shape known in the art, such as, but not limited to, shovels, brooms, hoes, rakes, axes, blades, etc.

Additionally, in one potential embodiment, the shaft is comprised of at least one pivot point. The pivot point changes the angle of the body of the attachment head to provide an optimal angle of the attachment head for using the device. The pivot point is comprised of at least one button. The button secures the body of the attachment head in a user's desired position for device usage.

During use, in one embodiment, the device is comprised of at least one handle, at least one shaft, and at least one attachment head. In the described embodiment, the device may be used as various shovels or pitchforks. In another potential embodiment of the device, it is only comprised of at least one shaft and at least one attachment head. During the use of a second embodiment, the device may be used as different shovels, brooms, hoes, rakes, etc.

Additionally, the device is comprised of a storage board to organize each component of the device. Furthermore, the storage board is comprised of a rear surface. The rear surface attaches to at least one wall of a garage, shed, or other storage receptacle. The rear surface attaches to at least one wall via at least one fastener. The storage board is also comprised of a front surface. The front surface of the storage board permits attachment to at least one fastener. The fastener of the front surface removably fixes at least one shaft, at least one handle, and at least one attachment head to the storage board.

The present invention is also comprised of a method of using the device. First, a device is provided comprised of a handle, a shaft, and an attachment head. Then, at least one fastener of a handle is fixed to at least one first fastener of a first end of the shaft. Then, at least one second fastener of a second end of the shaft is fixed to at least one fastener of a body of the attachment head. In one embodiment where the shaft is telescoping, a user can select the length of the shaft and lock the shaft into place via at least one locking member. In one embodiment where the shaft is comprised of at least one pivot point, a user adjusts the angle of the body of the attachment head and locks the attachment head into place via at least one button.

The present invention is also comprised of a second method of using the device. First, a device is provided comprised of a shaft and an attachment head. Then, at least one second fastener of a second end of the shaft is fixed to at least one fastener of a body of the attachment head. In one embodiment where the shaft is telescoping, a user can select the length of the shaft and lock the shaft into place via at least one locking member. In one embodiment where the shaft is comprised of at least one pivot point, a user adjusts the angle of the body of the attachment head and locks the attachment head into place via at least one button.

Accordingly, the interchangeable garden tool device of the present invention is particularly advantageous as it provides a device that exchanges tool heads on a shaft to eliminate the need for individual tools. The interchangeable garden tool device provides a user with a tool that accomplishes all yard working or gardening needs without carrying around multiple tools. Additionally, the interchangeable garden tool device may attach to a mountable storage frame. The mountable storage frame stores the shaft and interchangeable tool heads to prevent clutter in a garage, shed, or another storage receptacle. In this manner, the interchangeable garden tool device overcomes the limitations of existing tools known in the art.

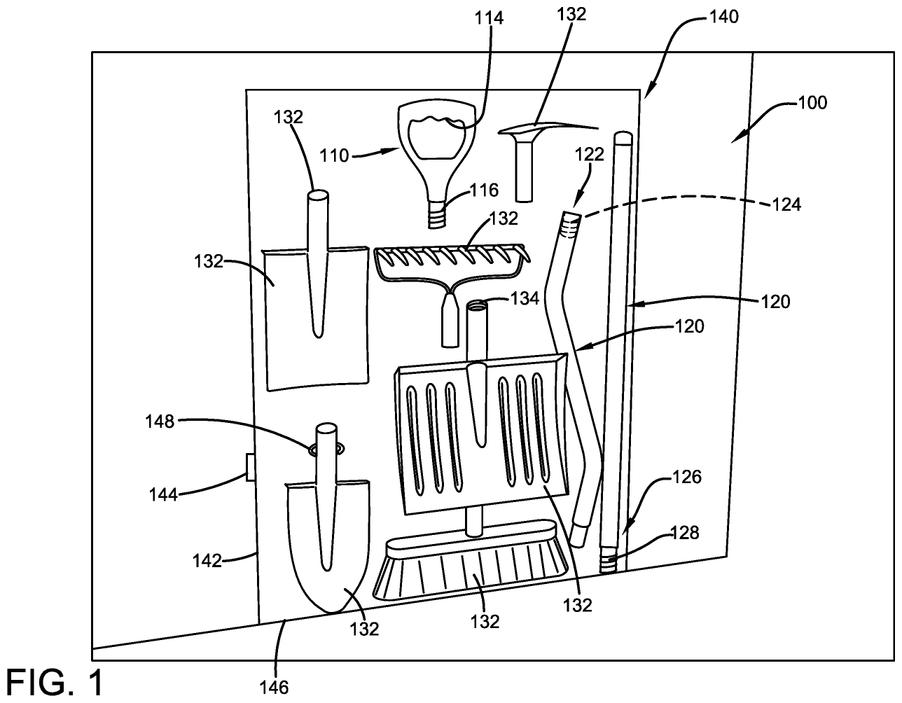

Referring initially to the drawings, FIG. 1 illustrates a perspective view of the device 100 in its preferred storage utilization in one potential embodiment in accordance with the disclosed architecture. The device 100 is comprised of at least one storage board 140 that organizes and stores each component of the device 100. The storage board 140 is comprised of a rear surface 142. The rear surface 142 attaches the storage board 140 to at least one wall of any storage receptacle known in the art, such as, but not limited to, a garage or shed wall. The rear surface 142 attaches to at least one wall via at least one fastener 144. The fastener 144 can be any type known in the art, such as, but not limited to, a magnet, a screw, a clip, a hook and loop fastener, an adhesive fastener, etc. Additionally, the storage board 140 is comprised of a front surface 146. The front surface 146 allows for the attachment of at least one fastener 148. The fastener 148 connects to a shaft 120 and a body 132 of an attachment head 130 to removably fix the shaft 120 and attachment head 130 to the storage board 140. The fastener 148 may be any type known in the art, such as, but not limited to, a magnet, a screw, a clip, a hook and loop fastener, an adhesive fastener, etc.

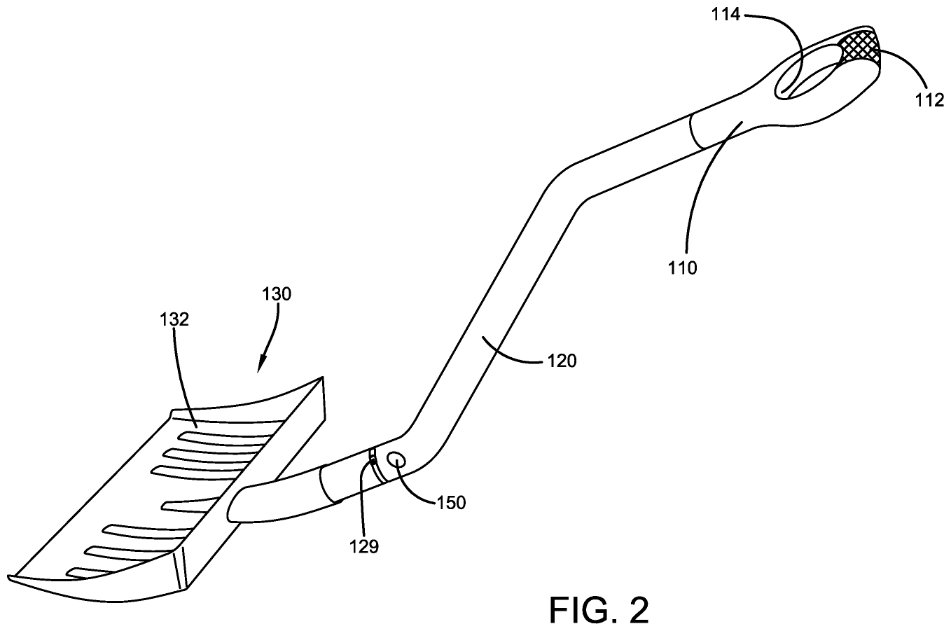

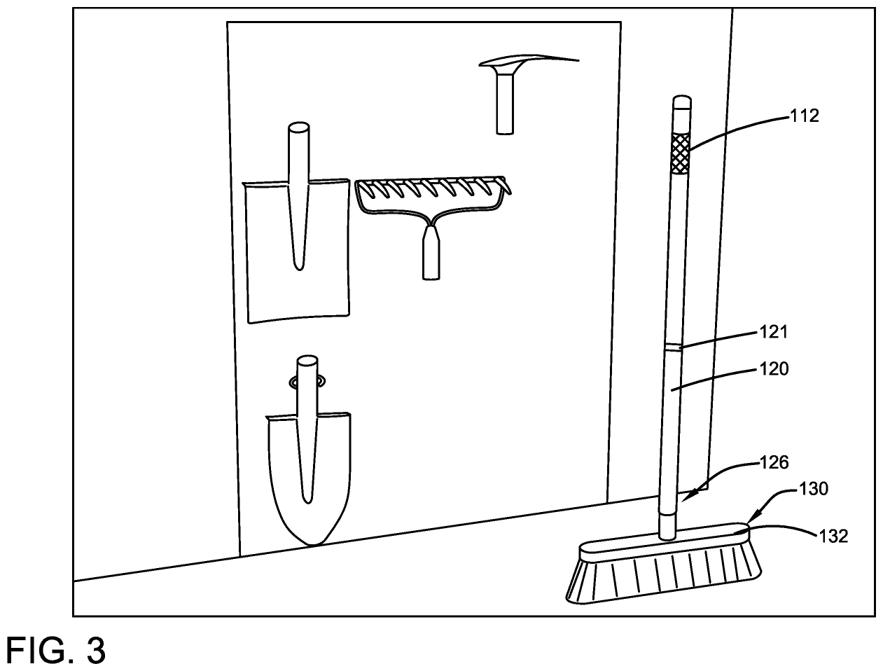

FIG. 2 illustrates a perspective view of one potential embodiment of a shaft 120 of an interchangeable garden tool device 100 of the present invention in accordance with the disclosed architecture. The shaft 120 allows a user to handle the device 100 while doing yardwork, gardening work, outdoor work, etc. The shaft 120 can be any shape known in the art, such as, but not limited to, a straight shaft, as seen in FIG. 3, an angular shaft, a flexible shaft, etc. In one potential embodiment, the shaft 120 may be made of any metal known in the art, such as, but not limited to, steel, aluminum, copper, iron, etc. In another potential embodiment, the shaft 120 may be made from any other material known in the art, such as, but not limited to, plastic, composite, wood, fiberglass, etc.

Additionally, the shaft 120 has a first end 122. The first end 122 is comprised of at least one first fastener 124. The first fastener 124 removably attaches to a handle 110 via at least one fastener 116. The first fastener 124 of the shaft 120 and the fastener 116 of the handle 110 are preferably male and female reciprocating fasteners. In one potential embodiment of the device 100, the fastener 116 of the handle 110 is comprised of at least one male fastener with at least one male thread that attaches to the first fastener 124 of the shaft 120, which is comprised of at least one female fastener with at least one female thread. In another embodiment, the fastener 116 and the first fastener 124 can be any other type of fastener known in the art, such as, but not limited to, a magnet fastener, tongue and groove fastener, etc.

Furthermore, the handle 110 (or shaft 120) has at least one grip area 112. The grip area 112 is for a user to grasp while using the device 100. The grip area 112 may be comprised of any non-slip material known in the art, such as, but not limited to, rubber, silicone, foam, etc. The grip area 112 may have a raised or recessed texture to promote grip while using the device 100. Additionally, the handle 110 has at least one opening 114. The opening 114 is an area for a user to stick their hand through while holding or using the device 100. The opening 114 can be any shape known in the art, such as, but not limited to, a circle, an oval, a square, etc.

In one embodiment of the shaft 120 of the interchangeable garden tool device 100, the shaft 120 may be fixed in length. In another potential embodiment, the shaft 120 may be telescoping to lengthen or shorten the device for better reachability or storage. In the telescoping embodiment, the shaft 120 has at least one locking member 121, as seen in FIG. 3. The locking member 121 allows the shaft 120 to expand or retract to specific lengths while locking the shaft 120 in place. The locking member 121 can be any type of lock known in the art, such as, but not limited to, a twisting lock, a button lock, a ball-lock pin, a telescoping clamp, a compression ring, etc.

The shaft 120 also has a second end 126. The second end 126 is comprised of at least one second fastener 128, as seen in FIG. 1. The second fastener 128 attaches to an attachment head 130 via at least one fastener 134. The second fastener 128 of the shaft 120 and the fastener 134 of the attachment head 130 are preferably reciprocating fasteners with a male end and a female end. In one potential embodiment of the device 100, the second fastener 128 of the shaft 120 is comprised of at least one male fastener with at least one male thread that attaches to the fastener 134 of the attachment head 130, which is comprised of at least one female fastener with at least one female thread. In another embodiment, the second fastener 128 and the fastener 134 can be any other type of fastener known in the art, such as, but not limited to, a magnet fastener, tongue and groove fastener, etc.

Moreover, the shaft 120 has at least one pivot point 129. The pivot point 129 allows a user to change the angle of the body 132 of the attachment head 130, as seen in FIG. 2. In one potential embodiment of the device 100, the pivot point 129 may be a hinge. In another embodiment of the device, the pivot point 129 may be any type of pivot point known in the art, such as, but not limited to, a swivel joint, a rotary joint, etc. Additionally, the pivot point 129 is comprised of at least one button 150. The button 150 locks the pivot point 129 so the body 132 of the attachment head 130 is secured at the desired angle for working with the device 100.

In different embodiments of the attachment head 130, the body 132 of the attachment head 130 may be a plurality of tool shapes such as, but not limited to, a snow shovel, a flat shovel, a spade shovel, an edging shovel, a trench shovel, a post-hole shovel, a scoop shovel, a root shovel, a pointed-digger shovel, a corn broom, a push broom, an angled broom, a dustpan broom, a digging hoe, a draw hoe, a reciprocating hoe, a flat hoe, a sweeping hoe, a gardening rake, a landscape rake, a thatch rake, a leaf rake, a shrub rake, a stone rake, a concrete rake, a hay rake, a hand rake, a lake rake, a room rake, a fire rake, a berry rake, an axe, a pickaxe, a pitchfork, a saw blade, a sledge hammer head, a scythe, a tamper, etc., or any other tool head known in the art.

During use of one potential embodiment, the device 100 has a handle 110, a shaft 120, and an attachment head 130. In this embodiment, the device 100 may be used as a snow shovel, a flat shovel, a spade shovel, a trench shovel, a scoop shovel, a root shovel, a pointed-digger shovel, an edging shovel, or a pitchfork. During the use of a second embodiment, the device 100 only has a shaft 120 and an attachment head 130. In the second embodiment, the device 100 may be used as a post-hole shovel, a corn broom, a push broom, an angled broom, a dustpan broom, a digging hoe, a draw hoe, a reciprocating hoe, a flat hoe, a sweeping hoc, a gardening rake, a landscape rake, a thatch rake, a leaf rake, a shrub rake, a stone rake, a concrete rake, a hay rake, a hand rake, a lake rake, a room rake, a fire rake, a berry rake, an axe, a pickaxe, a saw blade, a sledgehammer head, a scythe, or a tamper.

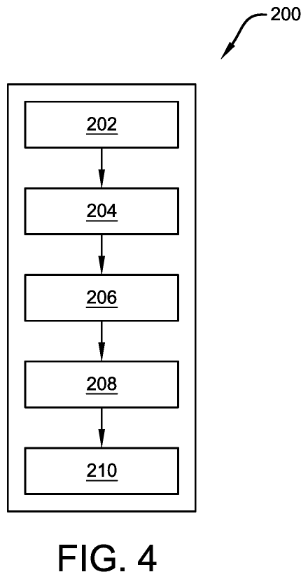

The present invention is also comprised of a method of using 200 the device 100, as seen in FIG. 4. First, a device 100 is provided comprised of a handle 110, a shaft 120, and an attachment head 130 [Step 202]. Then, at least one fastener 116 of a handle 110 is attached to at least one first fastener 124 of a first end 122 of the shaft 120 [Step 204]. Then, at least one second fastener 128 of a second end 126 of the shaft 120 is fixed to at least one fastener 134 of a body 132 of the attachment head 130 [Step 206]. In one embodiment where the shaft 120 is telescoping, a user can select the length of the shaft 120 and lock the shaft 120 into place via at least one locking member 121 [Step 208]. In one embodiment where the shaft 120 is comprised of at least one pivot point 129, a user adjusts the angle of the body 132 of the attachment head 130 and locks the attachment head 130 into place via at least one button 150 [Step 210].

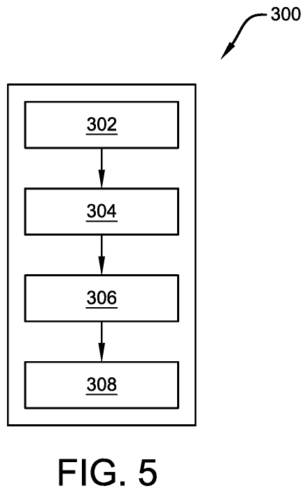

The present invention is also comprised of a second method of using 300 the device 100, as seen in FIG. 5. First, a device 100 is provided comprised of a shaft 120 and an attachment head 130 [Step 302]. Then, at least one second fastener 128 of a second end 126 of the shaft 120 is fixed to at least one fastener 134 of a body 132 of the attachment head 130 [Step 304]. In one embodiment where the shaft 120 is telescoping, a user can select the length of the shaft 120 and lock the shaft 120 into place via at least one locking member 121 [Step 306]. In one embodiment where the shaft 120 is comprised of at least one pivot point 129, a user adjusts the angle of the body 132 of the attachment head 130 and locks the attachment head 130 into place via at least one button 150 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “interchangeable garden tool device” and “device” are interchangeable and refer to the interchangeable garden tool device 100 of the present invention.

Notwithstanding the foregoing, the interchangeable garden tool device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the interchangeable garden tool device 100 as shown in the FIGS. are for illustrative purposes only, and that many other sizes and shapes of the interchangeable garden tool device 100 are well within the scope of the present disclosure. Although the dimensions of the interchangeable garden tool device 100 are important design parameters for user convenience, the interchangeable garden tool device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interchangeable garden tool device comprising:
a handle comprised of a first fastener and an opening;
a shaft comprised of a first end comprised of a first end fastener and a second end comprised of a second end fastener; and
an attachment head comprised of a body and an attachment head fastener.

2. The interchangeable garden tool device of claim 1, wherein the handle is comprised of a grip area.

3. The interchangeable garden tool device of claim 2, wherein the grip area is comprised of a raised or a recessed texture.

4. The interchangeable garden tool device of claim 1, wherein the first fastener and the first end fastener are comprised of a pair of reciprocating fasteners.

5. The interchangeable garden tool device of claim 1, wherein the second end fastener and the attachment head fastener are comprised of a pair of reciprocating fasteners.

6. The interchangeable garden tool device of claim 1 further comprised of a storage board comprised of a front surface comprised of a storage board fastener.

7. The interchangeable garden tool device of claim 1, wherein the shaft is comprised of a straight shaft or an angular shaft.

8. The interchangeable garden tool device of claim 1, wherein the shaft is comprised of a telescopic shaft that can be secured at a fixed length via a locking member.

9. The interchangeable garden tool device of claim 1, wherein the shaft is comprised of a pivot point.

10. The interchangeable garden tool device of claim 9, wherein the pivot point can be locked at a position via a button.

11. The interchangeable garden tool device of claim 1, wherein the body is comprised of a snow shovel, a flat shovel, a spade shovel, an edging shovel, a trench shovel, a post-hole shovel, a scoop shovel, a root shovel, a pointed-digger shovel, a corn broom, a push broom, an angled broom, a dustpan broom, a digging hoe, a draw hoe, a reciprocating hoe, a flat hoe, a sweeping hoe, a gardening rake, a landscape rake, a thatch rake, a leaf rake, a shrub rake, a stone rake, a concrete rake, a hay rake, a hand rake, a lake rake, a room rake, a fire rake, a berry rake, an axe, a pickaxe, a pitchfork, a saw blade, a sledge hammer head, a scythe, or a tamper.

12. The interchangeable garden tool device of claim 1, wherein the body is comprised of a post-hole shovel, a corn broom, a push broom, an angled broom, a dustpan broom, a digging hoe, a draw hoe, a reciprocating hoe, a flat hoe, a sweeping hoe, a gardening rake, a landscape rake, a thatch rake, a leaf rake, a shrub rake, a stone rake, a concrete rake, a hay rake, a hand rake, a lake rake, a room rake, a fire rake, a berry rake, an axe, a pickaxe, a saw blade, a sledgehammer head, a scythe, or a tamper.

13. An interchangeable garden tool device comprising:
a shaft comprised of a first end and a second end;
a first end fastener positioned on the first end;
a second end fastener positioned on the second end; and
an attachment head comprised of a body and an attachment head fastener.

14. The interchangeable garden tool device of claim 13, wherein the first fastener and the first end fastener are comprised of a pair of reciprocating threads.

15. The interchangeable garden tool device of claim 13, wherein the second end fastener and the attachment head fastener are comprised of a pair of reciprocating threads.

16. The interchangeable garden tool device of claim 13, wherein the shaft is comprised of a telescopic shaft that can be secured at a fixed length via a locking member.

17. The interchangeable garden tool device of claim 13, wherein the body is comprised of a snow shovel, a flat shovel, a spade shovel, an edging shovel, a trench shovel, a post-hole shovel, a scoop shovel, a root shovel, a pointed-digger shovel, a corn broom, a push broom, an angled broom, a dustpan broom, a digging hoe, a draw hoe, a reciprocating hoe, a flat hoe, a sweeping hoe, a gardening rake, a landscape rake, a thatch rake, a leaf rake, a shrub rake, a stone rake, a concrete rake, a hay rake, a hand rake, a lake rake, a room rake, a fire rake, a berry rake, an axe, a pickaxe, a pitchfork, a saw blade, a sledge hammer head, a scythe, or a tamper.

18. The interchangeable garden tool device of claim 13, wherein the body is comprised of a post-hole shovel, a corn broom, a push broom, an angled broom, a dustpan broom, a digging hoe, a draw hoe, a reciprocating hoe, a flat hoe, a sweeping hoe, a gardening rake, a landscape rake, a thatch rake, a leaf rake, a shrub rake, a stone rake, a concrete rake, a hay rake, a hand rake, a lake rake, a room rake, a fire rake, a berry rake, an axe, a pickaxe, a saw blade, a sledgehammer head, a scythe, or a tamper.

19. A method of using an interchangeable garden tool device, the method comprising the following steps:
providing an interchangeable garden tool device comprised of a handle, shaft, and an attachment head;
attaching a fastener of the handle to a first end fastener of a first end of the shaft; and
attaching a second end fastener of a second end of the shaft to a fastener of the attachment head.

20. The method of claim 19, wherein the attachment head is comprised of a snow shovel, a flat shovel, a spade shovel, an edging shovel, a trench shovel, a post-hole shovel, a scoop shovel, a root shovel, a pointed-digger shovel, a corn broom, a push broom, an angled broom, a dustpan broom, a digging hoe, a draw hoe, a reciprocating hoe, a flat hoe, a sweeping hoe, a gardening rake, a landscape rake, a thatch rake, a leaf rake, a shrub rake, a stone rake, a concrete rake, a hay rake, a hand rake, a lake rake, a room rake, a fire rake, a berry rake, an axe, a pickaxe, a pitchfork, a saw blade, a sledge hammer head, a scythe, or a tamper.
